(19) United States
(12) Patent Application Publication
(10) Pub. No.: US 2022/0013062 A1
(43) Pub. Date: Jan. 13, 2022

(54) ADJUSTING DEVICE AND METHOD FOR ADJUSTING DRIVING VOLTAGE OF LIGHT-EMITTING ELEMENT

(71) Applicant: Coretronic Corporation, Hsin-Chu (TW)

(72) Inventors: Fang Yu Hsieh, Hsin-Chu (TW); Ho-Yi Yeh, Hsin-Chu (TW); Kuo Tsung Chen, Hsin-Chu (TW)

(73) Assignee: Coretronic Corporation, Hsin-Chu (TW)

(21) Appl. No.: 17/308,060

(22) Filed: May 5, 2021

(30) Foreign Application Priority Data
Jul. 7, 2020 (CN) 202010644471.1

(51) Int. Cl. G09G 3/32

(52) U.S. Cl. CPC G09G 3/32; G09G 2320/0626; G09G 2330/023; G09G 2330/028; G09G 2310/0289

(57) ABSTRACT

An adjusting device for adjusting a driving voltage of a light-emitting element is provided. The adjusting device includes a driving circuit and a control circuit. The control circuit is configured to generate a voltage difference. A control signal indicates that brightness of a display is adjusted from first brightness of the display to second brightness of the display, and the driving circuit adjusts the driving voltage according to the voltage difference. The control circuit queries a look-up table to obtain a first voltage corresponding to the first brightness of the display and a second voltage corresponding to the second brightness of the display. The voltage difference is obtained from the difference between the first voltage and the second voltage. The first voltage and second voltage respectively indicate the minimum cross-voltages required by the light-emitting element under the first brightness of the display and the second brightness of the display.

### CROSS-REFERENCE TO RELATED APPLICATION

This application claims the priority benefit of China application serial no. 202010644471.1, filed on Jul. 7, 2020. The entirety of the above-mentioned patent application is hereby incorporated by reference herein and made a part of this specification.

### BACKGROUND

### Technical Field

The disclosure relates to a driving circuit of a display, and in particular to a driving circuit that can automatically adjust a driving voltage of a light-emitting element according to brightness of a display set by a user.

### Description of Related Art

A user can adjust brightness of a display, for example, through a button. When the user adjusts the brightness of the display, the display adjusts the driving current provided to the light-emitting element to a corresponding current. However, the driving voltage of the display is fixed and does not change with the driving current.

When the user demands higher brightness, the driving current of the light-emitting element is greater, and so is the cross-voltage of the light-emitting element. However, since the driving voltage is fixed, it is possible that no sufficient cross-voltage is provided to the light-emitting element. In contrast, when the user dims the brightness of the display, the driving current of the light-emitting element becomes smaller, and therefore the light-emitting element does not need such a high cross-voltage. However, since the driving voltage is fixed, the light-emitting element still generates power, leading to power losses. In addition, changes of the ambient temperature may also affect the cross-voltage of the light-emitting element, resulting in unnecessary power losses.

Therefore, it is necessary to propose a technical solution through which the driving voltage is adjusted when the brightness of the display is adjusted, so as to optimize the luminous efficiency and improve the possible power losses.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an adjusting device and an adjusting method for adjusting a driving voltage of a light-emitting element so that the driving voltage provided to the light-emitting element can be automatically adjusted according to the brightness of the display set by the user.

In the embodiments of the disclosure, an adjusting device for adjusting a driving voltage of a light-emitting element is provided. The adjusting device is configured to a display including the light-emitting element. The adjusting device includes a driving circuit and a control circuit. The driving circuit is configured to provide the light-emitting element with a driving voltage and a driving current. The control circuit is coupled to the light-emitting element and the driving circuit and is configured to start a driving voltage adjustment procedure to generate a voltage difference according to a control signal S. The control signal indicates that the brightness of the display is adjusted from first brightness of the display to second brightness of the display by the user, and the driving circuit is further configured to adjust the driving voltage according to the voltage difference. In the driving voltage adjustment procedure, the control circuit is configured to query a look-up table according to the control signal to obtain a first voltage corresponding to the first brightness of the display and a second voltage corresponding to the second brightness of the display. The first voltage and the second voltage respectively indicate the minimum cross-voltages required by the light-emitting element under the first brightness of the display and the second brightness of the display. The control circuit is also configured to calculate a difference between the first voltage and the second voltage to obtain the voltage difference.

In the embodiments of the disclosure, an adjusting method for adjusting a driving voltage of a light-emitting element is provided. The adjusting method is adapted to be performed in a display comprising the light-emitting element. The adjusting method includes providing the light-emitting element with a driving voltage and a driving current; receiving a control signal indicating that brightness of the display is adjusted from first brightness of the display to second brightness of the display by a user; starting a driving voltage adjustment procedure to generate a voltage difference according to the control signal, adjusting the driving voltage according to the voltage difference. In starting a driving voltage adjustment procedure to generate a voltage difference according to the control signal, the driving voltage adjustment procedure further includes querying a look-up table according to the control signal to obtain a first voltage corresponding to the first brightness of the display and a second voltage corresponding to the second brightness of the display and calculating a difference between the first voltage and the second voltage to obtain the voltage difference. The first voltage and the second voltage respectively indicate the minimum cross-voltages required by the light-emitting element under the first brightness of the display and the second brightness of the display.

Based on the above, in the disclosure, when the user adjusts the brightness of the display, the control circuit of the adjusting device for adjusting the driving circuit starts the driving voltage adjustment procedure to adjust the driving voltage according to the control signal. In this way, by adjusting the driving voltage provided to the light-emitting element, the luminous efficiency of the display can be optimized and the possible power loss can be improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic block view of an adjusting device for adjusting a driving voltage of a light-emitting element according to an embodiment of the disclosure.

FIG. 2 is a schematic view of a look-up table according to an embodiment of the disclosure.

FIG. 3 is a schematic block view of an adjusting device for adjusting a driving voltage of a light-emitting element according to another embodiment of the disclosure.

FIG. 4 is a schematic view illustrating an adjusting method for adjusting a driving voltage of a light-emitting element according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Reference will now be made in detail to the preferred embodiments of the disclosure, and examples of which are illustrated in the accompanying drawings. Wherever possible, the same reference numbers are used in the drawings and the description to refer to the same or like parts

The foregoing and other technical contents, features and effects of the disclosure will be clearly presented in the following detailed description with reference to one of the preferred embodiments of the accompanying drawings. Directional terms mentioned in the following embodiments, for example: up, down, left, right, front or back, etc., are only directions referring to the drawings. Therefore, the directional terminology is configured to illustrate rather than limit the disclosure.

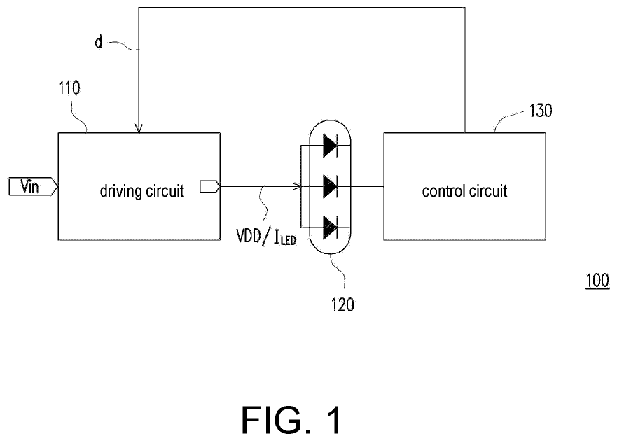

FIG. 1 is a schematic block view of an adjusting device for adjusting a driving voltage of a light-emitting element according to an embodiment of the disclosure. Referring to FIG. 1, an adjusting device 100 includes a driving circuit 110, a light-emitting element 120, and a control circuit 130. The driving circuit 110 is coupled to the light-emitting element 120. The driving circuit 110 is configured to receive a power Vin to generate a driving voltage VDD and a driving current I_{LED} and provides the light-emitting element 120 with the driving voltage VDD and the driving current I_{LED}. Those skilled in the art can easily know hardware such as circuits, integrated circuits, or chips corresponding to the driving circuit 110. When a user adjusts brightness of a display, for example, through a button, the driving circuit 110 adjusts the driving current I_{LED} provided to the light-emitting element to a corresponding current. For example, when the user increases the brightness of the display from first brightness of the display to second brightness of the display, the driving circuit 110 can increase the driving current I_{LED} provided to the light-emitting element 120 by increasing a duty cycle of a pulse width modulation (PWM) signal. In the embodiment, the light-emitting element 120 may be, but not limited to, a light-emitting diode (LED) or a laser diode (LD), and the luminous intensity of the light-emitting element is proportional to the driving current I_{LED} provided to the light-emitting element 120.

The control circuit 130 is coupled to the light-emitting element 120 and the driving circuit 110. The control circuit 130 is configured to start a driving voltage adjustment procedure to generate a voltage difference d according to a control signal S, thereby adjusting the driving voltage VDD. The control circuit 130 is, for example, a microprocessor, a central processing unit (CPU), or other programmable general-purpose or special-purpose microprocessor, a digital signal processor (DSP), a programmable controller, application specific integrated circuits (ASICs), a programmable logic device (PLD), other similar devices, or a combination thereof.

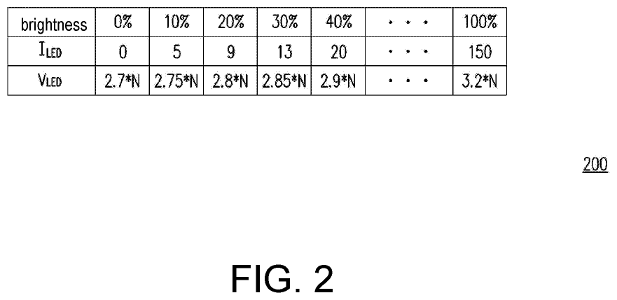

The control signal S indicates that the brightness of the display is adjusted by the user from the first brightness of the display to the second brightness of the display different from the first brightness of the display. In the driving voltage adjustment procedure, the control circuit 130 obtains the voltage difference d by querying a pre-stored look-up table. FIG. 2 is a schematic view of a look-up table according to an embodiment of the disclosure. Referring to FIG. 2, the first row of a look-up table 200 includes a plurality of brightness information of the display expressed by the duty cycle. The second row includes a plurality of driving currents I_{LED} corresponding to the plurality of brightness information of the display in the first row. Each driving current I_{LED} represents the minimum driving current required by the light-emitting element corresponding to the brightness of the display in milliampere. The third row includes a plurality of cross-voltages V_{LED} of the plurality of the light-emitting elements corresponding to the plurality of brightness information of the display in the first row. The cross-voltage V_{LED} of each light-emitting element represents the minimum cross-voltage required by the light-emitting element corresponding to the brightness of the display. In detail, the minimum driving current is based on the datasheet of the light-emitting element or the display to meet the minimum driving current required by the light-emitting element or to correspond to the minimum driving current required by the display according to its brightness.

In addition, referring to FIG. 2, the figures “2.7”, “2.75” . . . , “3.2” listed in the third row refer to the minimum cross-voltage of an individual light-emitting element corresponding to the brightness of the display in volt. In practical applications, the values in the third row vary with the number of the light-emitting elements connected in series. For convenience of explanation, the minimum cross-voltages of the plurality of light-emitting elements in the third row are presented in the form of “value *N”. An N represents the number of the light-emitting elements connected in series, and the N is set in advance.

Referring to FIG. 1 and FIG. 2, the control circuit 130 queries the look-up table 200 according to the control signal S and obtains two cross-voltages V_{LED} corresponding to the brightness of the display before adjustment and the brightness of the display after adjustment. The brightness of the display is related to the control signal S that indicates the duty cycle of the PWM signal of the driving circuit 130. For example, the control signal S indicates that the brightness of the display is adjusted by the user from 20 brightness to 40 brightness, and further indicates that the duty cycle of the PWM signal is adjusted from 20% to 40%. Meanwhile, the control circuit 130 queries the look-up table according to the control signal S and obtains “2.8*N” corresponding to the duty cycle of 20% and “2.9*N” corresponding to the duty cycle of 40%. The control circuit 130 further calculates the difference between “2.8*N” and “2.9*N” (i.e., the voltage difference is +0.1*N) and provides the driving circuit 110 with the voltage difference, so that the driving circuit 110 adjusts the driving voltage VDD according to the voltage difference. In the embodiment, the driving circuit 110 increases the current driving voltage VDD by 0.1*N (in volt) according to the voltage difference (+0.1*N).

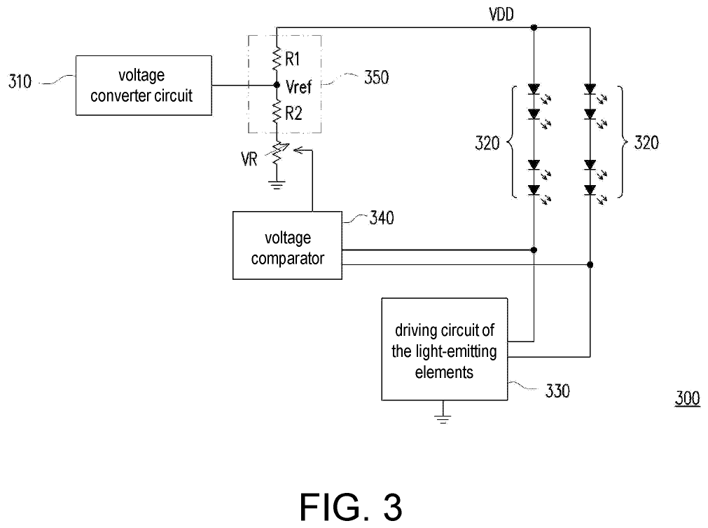

FIG. 3 is a schematic block view of an adjusting device for adjusting a driving voltage of a light-emitting element according to another embodiment of the disclosure. Referring to FIG. 3, an adjusting device 300 includes a voltage converter circuit 310 (it is at least included by the driving circuit 110), a light-emitting element 320, a driving circuit of the light-emitting element(s) 330 (it is at least included by the driving circuit 110), and a voltage comparator 340 (voltage adjusting circuit). In addition, the adjusting device 300 further includes a voltage dividing circuit 350 and a variable resistor VR coupled to the voltage dividing circuit 350. For example, the voltage dividing circuit 350 may be, but not limited to, a part of the voltage converter circuit 310. The voltage dividing circuit 350 includes a resistor R1 and a resistor R2 coupled in series. The variable resistor VR is coupled between a reference ground potential and the resistor R2. The variable resistor VR may be a part of the voltage comparator 340 or may be disposed independently of the voltage comparator 340. A node between the resistor R1 and the resistor R2 provides a reference voltage Vref. The voltage converter circuit 310 is configured to provide the driving voltage VDD according to the reference voltage Vref. The driving circuit of the light-emitting element(s) 330 is configured to provide a corresponding driving current I_{LED} according to the current brightness of the display. The light-emitting element 320 is driven by the driving voltage VDD and the driving current I_{LED} to emit light. The voltage converter circuit 310 and the driving circuit of the light-emitting element(s) 330 function in the same manner as the driving circuit 110 in FIG. 1.

The voltage comparator 340 serves to adjust the voltage value of the driving voltage VDD according to the voltage change of the cross-voltage of the light-emitting element 320 obtained by the voltage comparator 340 after the brightness of the display is adjusted, but the cross-voltage of the light-emitting element 320 changes due to factors such as temperatures. The voltage comparator 340 has a plurality of input terminals to detect the voltage change on each path of the light-emitting elements 320 connected in series. Referring to FIG. 3, one terminal of the voltage comparator 340 is coupled to the downstream of the light-emitting element 320 connected in series to detect the cross-voltage of the light-emitting element 320. Specifically, the voltage comparator 340 periodically detects the cross-voltage (the cross-voltage from the VDD terminal to the input terminal) of the light-emitting element 320 and compares the detected current cross-voltage with the previous cross-voltage to obtain a voltage change. The voltage comparator 340 adjusts the resistance of the variable resistor VR according to the voltage change. Specifically, the voltage comparator 340 decreases the resistance of the variable resistor according to the voltage change, thereby increasing the driving voltage; alternatively, the voltage comparator 340 may increase the resistance of the variable resistor according to the voltage change, thereby decreasing the driving voltage.

For example, when the voltage comparator 340 detects that the current cross-voltage is 5V and the previous cross-voltage is 3V, the voltage change (e.g., an increase of 2V, which is a positive value) is obtained through comparison. Understandably, since the driving voltage VDD has deviated, the reference voltage Vref also deviates. Meanwhile, the voltage comparator 340 decreases the resistance of the variable resistor VR according to the voltage change, so that the reference voltage Vref is adjusted back to the default voltage. For example, the voltage comparator 340 may decrease the resistance of the variable resistor VR according to the positive voltage change. According to the voltage divider rule, the reference voltage Vref that has deviated decreases to the default voltage. Through the above operations, the driving voltage VDD generated by the voltage converter circuit 310 is increased. On the contrary, when the voltage comparator 340 detects that the cross-voltage change is a negative value, the resistance of the variable resistor VR is increased, and thereby the driving voltage VDD is decreased. The voltage comparator 340 may be an operational amplifier (OPA).

In an embodiment, the voltage comparator 340 may include an operational amplifier and a storage device. One of the non-inverting input terminal and the inverting input terminal of the operational amplifier receives the current cross-voltage, the other receives the previous cross-voltage, and the previous cross-voltage is stored in a commonly used storage device to calculate the voltage change. Specifically, a detection time difference between the current cross-voltage and the previous cross-voltage is set corresponding to when the temperature change is greater than a threshold, or according to a time interval, which corresponds to the refresh rate or the resolution of the display.

In an embodiment, the voltage comparator 340 may include a plurality of operational amplifiers, and the light-emitting element 320 may include a plurality of light-emitting elements connected in series, such as two light-emitting elements 320 connected in series (as shown in FIG. 3). Specifically, a detection terminal of each operational amplifier is coupled to a downstream of a light-emitting element 320 connected in series, so the voltage comparator 340 obtains a plurality of voltage changes and performs a calculation according to the plurality of the voltage changes to adjust the resistance of the variable resistance VR. The calculation may include, but is not limited to, obtaining values such as an average value and a maximum value of a plurality of voltage changes.

In the embodiment, the voltage comparator 340 may be a part of the control circuit shown in FIG. 1. In other embodiments, the voltage comparator 340 may also be disposed independently of the control circuit.

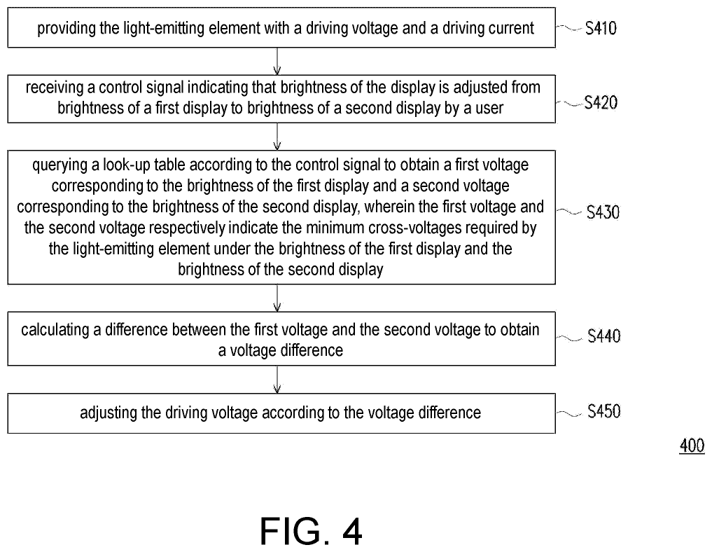

FIG. 4 is a schematic view illustrating an adjusting method for adjusting a driving voltage of a light-emitting element according to an embodiment of the disclosure. Referring to FIG. 1 and FIG. 4, in a step S410, the driving circuit 110 provides the light-emitting element 120 with the driving voltage VDD and the driving current I_{LED}. In a step S420, the control circuit 130 receives the control signal S. The control signal S indicates that the brightness of the display is adjusted by the user from the first brightness of the display to the second brightness of the display. Next, the control circuit 130 starts the driving voltage adjustment procedure to generate the voltage difference d according to the control signal S. The driving voltage adjustment procedure includes that the control circuit 130 queries the look-up table according to the control signal S to obtain a first voltage corresponding to the first brightness of the display and a second voltage corresponding to the second brightness of the display (i.e., a step S430). The first voltage and the second voltage respectively indicate the minimum cross-voltages required by the light-emitting elements corresponding to the first brightness of the display and the second brightness of the display. In addition, a step in which the control circuit 130 calculates the difference between the first voltage and the second voltage to obtain the voltage difference d is further included (i.e., a step S440). Finally, in a step S450, the driving circuit 110 adjusts the driving voltage VDD according to the voltage difference d.

Based on the above, when the user adjusts the brightness of the display, the control circuit of the adjusting device for adjusting the driving voltage in the disclosure starts the driving voltage adjustment procedure to adjust the driving voltage according to the control signal S. When the cross-voltage of the light-emitting element changes due to factors such as temperatures, the voltage comparator of the driving voltage adjusting device also adjusts the driving voltage in real time according to the detected voltage change. By adjusting the driving voltage provided to the light-emitting element through the above technical means, the luminous efficiency of the display can be optimized and the possible power losses can be improved.

However, the above are only preferred embodiments of the disclosure, and the scope of implementation of the disclosure cannot be limited thereto, that is, any simple equivalent changes and modifications made according to the claims of the disclosure and the content of the disclosure are still within the scope of the disclosure. In addition, any embodiment or claim of the disclosure does not need to achieve all the objects, advantages, or features disclosed by the disclosure. In addition, the abstract and the title of the disclosure are only used to assist in search of the documents of the disclosure, but not to limit the scope of the disclosure. In addition, the terms “first” and “second” mentioned in the specification or claims are only used to name elements or distinguish different embodiments or ranges, and are not used to limit the maximum or minimum number of elements.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An adjusting device for adjusting a driving voltage of a light-emitting element, configured to a display comprising the light-emitting element, wherein the adjusting device comprises a driving circuit and a control circuit,
wherein the driving circuit is configured to provide the light-emitting element with a driving voltage and a driving current;
the control circuit is coupled to the light-emitting element and the driving circuit and is configured to start a driving voltage adjustment procedure to generate a voltage difference according to a control signal S,
wherein the control signal indicates that brightness of the display is adjusted from first brightness of the display to second brightness of the display by a user, and the driving circuit is further configured to adjust the driving voltage according to the voltage difference,
wherein in the driving voltage adjustment procedure, the control circuit is configured to perform:
querying a look-up table according to the control signal to obtain a first voltage corresponding to the first brightness of the display and a second voltage corresponding to the second brightness of the display, wherein the first voltage and the second voltage respectively indicate the minimum cross-voltages required by the light-emitting element under the first brightness of the display and the second brightness of the display; and
calculating a difference between the first voltage and the second voltage to obtain the voltage difference.

2. The adjusting device for adjusting the driving voltage of the light-emitting element according to claim 1, wherein the look-up table comprises a plurality of brightness information of the display and a plurality of voltages corresponding to the plurality of brightness information of the display, the plurality of voltages respectively indicate different minimum cross-voltages required by the light-emitting element under a plurality of the brightness of the display.

3. The adjusting device for adjusting the driving voltage of the light-emitting element according to claim 1, wherein the adjusting device further comprises a voltage adjusting circuit coupled to the light-emitting element and the driving circuit, and the voltage adjusting circuit is configured to perform:
detecting a cross-voltage change of the light-emitting element to obtain a voltage change; and
adjusting a reference voltage of the driving circuit according to the voltage change, thereby affecting the driving voltage.

4. The adjusting device for adjusting the driving voltage of the light-emitting element according to claim 3, wherein the adjusting device further comprises a variable resistor and a voltage dividing circuit, and the voltage adjusting circuit is further configured to perform:
adjusting a resistance of the variable resistor according to the voltage change,
wherein the variable resistor is connected in series to the voltage dividing circuit, and the reference voltage of the driving circuit is obtained from a node of the voltage dividing circuit.

5. The adjusting device for adjusting the driving voltage of the light-emitting element according to claim 4, wherein when the second brightness of the display is greater than the first brightness of the display, the voltage adjusting circuit is further configured to perform:
decreasing a resistance of the variable resistor according to the voltage change, thereby increasing the driving voltage.

6. The adjusting device for adjusting the driving voltage of the light-emitting element according to claim 4, wherein when the first brightness of the display is greater than the second brightness of the display, the voltage adjusting circuit is further configured to perform:
increasing the resistance of the variable resistor according to the voltage change, thereby decreasing the driving voltage.

7. An adjusting method for adjusting a driving voltage of a light-emitting element, configured to be performed in a display comprising the light-emitting element, wherein the adjusting method comprises:
providing the light-emitting element with a driving voltage and a driving current;
receiving a control signal indicating that brightness of the display is adjusted from first brightness of the display to second brightness of the display by a user;
starting a driving voltage adjustment procedure to generate a voltage difference according to the control signal, wherein the driving voltage adjustment procedure comprises:
querying a look-up table according to the control signal to obtain a first voltage corresponding to the first brightness of the display and a second voltage corresponding to the second brightness of the display, wherein the first voltage and the second voltage respectively indicate the minimum cross-voltages required by the light-emitting element under the first brightness of the display and the second brightness of the display;
calculating a difference between the first voltage and the second voltage to obtain the voltage difference; and
adjusting the driving voltage according to the voltage difference.

8. The adjusting method for adjusting the driving voltage of the light-emitting element according to claim 7, wherein the look-up table comprises a plurality of brightness information of the display and a plurality of voltages corresponding to the plurality of brightness information of the display, the plurality of the voltages respectively indicate different minimum cross-voltages required by the light-emitting element under a plurality of brightness of the display.

9. The adjusting method for adjusting the driving voltage of the light-emitting element according to claim 7, further comprising:
detecting a cross-voltage change of the light-emitting element to obtain a voltage change; and
adjusting and generating a reference voltage required by the driving circuit according to the voltage change, thereby affecting the driving voltage.

10. The adjusting method for adjusting the driving voltage of the light-emitting element according to claim 9, further comprising:
adjusting a resistance of a variable resistor according to the voltage change,
wherein the variable resistor is connected in series to a voltage dividing circuit, and the reference voltage is obtained from a node of the voltage dividing circuit.

11. The adjusting method for adjusting the driving voltage of the light-emitting element according to claim 10, wherein when the second brightness of the display is greater than the first brightness of the display, the adjusting method further comprises:
decreasing the resistance of the variable resistor according to the voltage change, thereby increasing the driving voltage.

12. The adjusting method for adjusting the driving voltage of the light-emitting element according to claim 10, wherein when the first brightness of the display is greater than the second brightness of the display, the adjusting method further comprises:
increasing the resistance of the variable resistor according to the voltage change, thereby decreasing the driving voltage.
